(19) United States
(12) Patent Application Publication
(10) Pub. No.: US 2025/0138647 A1
(43) Pub. Date: May 1, 2025

(54) SYSTEM AND METHOD FOR A QUIET MAGNETIC KEYBOARD KEY

(71) Applicant: Dell Products, LP, Round Rock, TX (US)

(72) Inventors: Peng Lip Goh, Singapore (SG); Deeder M. Aurongzeb, Austin, TX (US)

(73) Assignee: Dell Products, LP, Round Rock, TX (US)

(21) Appl. No.: 18/384,161

(22) Filed: Oct. 26, 2023

(51) Int. Cl. G06F 3/02

(52) U.S. Cl. CPC G06F 3/0202

(57) ABSTRACT

A keyboard operatively couplable to an information handling system includes a keyboard top cover including at least one keyboard key well formed therein, a keyboard key cap having a keyboard key cap lower extension to fit within the keyboard key well, and a keyboard key well magnet formed on an interior vertical surface inside the keyboard key well. The keyboard further includes a keyboard key cap magnet formed on and outer surface of the keyboard key cap lower extension of the sliding surface of the keyboard key cap aligned in parallel vertically with the keyboard key well magnet, wherein magnetic interaction between the keyboard key cap magnet and the keyboard key cap magnet slidably holds the keyboard key cap to the keyboard key well.

### FIELD OF THE DISCLOSURE

The present disclosure generally relates to a keyboard. The present disclosure more specifically relates to a keyboard having a quiet magnetic keyboard keys that reduces or eliminates noises during actuation of the keyboard key.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more gaming applications. Further, the information handling system may include any number of peripheral devices including a keyboard used to provide input to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a keyboard having a plurality of magnetic keyboard keys according to an embodiment of the present disclosure;

FIG. 2 is a top view of a magnetic keyboard key formed into the keyboard according to an embodiment of the present disclosure;

FIG. 3 is a top perspective exploded view of a magnetic keyboard key formed into the keyboard showing a keyboard key well magnet and a keyboard key cap magnet according to another embodiment of the present disclosure;

FIG. 4 is a top perspective view of a magnetic keyboard key well formed into the keyboard showing a keyboard key well magnet according to another embodiment of the present disclosure;

FIG. 5 is a bottom perspective view of a keyboard key cap of a keyboard showing the keyboard key cap magnets on a lower extension of the key cap according to another embodiment of the present disclosure;

FIG. 6 is a side, cross-sectional view of a magnetic keyboard key of a keyboard in an unactuated state according to an embodiment of the present disclosure;

FIG. 7 is a side, cross-sectional view of a magnetic keyboard key of a keyboard in an actuated state according to an embodiment of the present disclosure; and

FIG. 8 is a block flow diagram illustrating a method of manufacturing a keyboard according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems include input/output I/O devices that allow a user to interface with the information handling system. Some of these I/O devices may be wireless I/O devices that transceive data to and from the wireless I/O device or wired I/O devices that transmit data to and from the information handling system via a wired connection at, for example a universal serial bus (USB) port. Some of these wired and wireless I/O devices include a wired or wireless keyboard. The wired or wireless keyboard may include a plurality of keys that allows a user to provide function data, alphanumeric data, and the like to the information handling system. The keyboard keys may be arranged in any order such as a QWERTY-type keyboard. These keyboard keys may be actuated in order to, for example, generate characters in a document at a word processing application executed on the information handling system. An undesirable user experience during typing may occur where the noise of the actuation of the keyboard keys is constant. The sound of this clacking noise during such typing, for example, may be partially caused by a key cap plastic hook holding the key cap on each keyboard key striking a top plastic keyboard cover hook when the keyboard key is released after actuation.

The present specification describes a keyboard operatively couplable to an information handling system that includes a keyboard top cover including at least one keyboard key well formed therein and a keyboard key cap having a lower extension with a sliding surface to fit within the keyboard key well. A keyboard key well magnet is formed on an interior vertical surface of the keyboard key well and a keyboard key cap magnet formed on an outer surface of the lower extension of the keyboard key cap. The magnetic interaction between the keyboard key well magnet and the keyboard key cap magnet slidably holds the keyboard key cap to the keyboard key well via its lower extension. Additionally, the magnetic interaction between the keyboard key cap magnet and the keyboard key cap magnet also reduces or eliminates the clacking noise usually associated with the actuation and release of a keyboard key.

In an embodiment, a lubricant is layered between the sliding surface of the keyboard key cap and the interior surface of the keyboard key well. This may be done to further reduce the clacking noise between the keyboard key cap and the keyboard key well where present as well as allow the keyboard key cap to interface with the keyboard key well with reduced friction thereby reducing the resistance by the user to actuate the keyboard key.

In an embodiment, a plurality of keyboard key well magnets may be formed on the interior surface of the keyboard key well vertically inside the keyboard key well. In an embodiment, a first keyboard key well magnet is formed on or operatively coupled to a first side of the keyboard key well and a second keyboard key well magnet is formed on or operatively coupled to a second, perpendicular side of the keyboard key well. Similarly, a plurality of keyboard key cap magnets may be formed on the lower extension of the keyboard key cap. In an embodiment, a first keyboard key cap magnet is formed on or operatively coupled to a first side of the keyboard key cap lower extension and a second keyboard key cap magnet is formed or operatively coupled to a second, perpendicular side of the keyboard key cap lower extension. This arrangement of the keyboard key cap magnets and keyboard key well magnets may properly align the keyboard key cap relative to the keyboard key well so that the user may not detect additional resistance when actuating a keyboard key.

In an embodiment, a keyboard key rubber dome may be formed within the at least one keyboard key well. In an embodiment, the rubber dome provides for actuation of the keyboard key during a keystroke including an upward force on the keyboard key cap while the magnetic interaction between the keyboard key cap magnet and keyboard key well magnet slidably holds the keyboard key cap in the keyboard key well. This keyboard key rubber dome may include a rubber dome retention extension formed at a top surface of the rubber dome. In an embodiment, this rubber dome retention extension passes into a retention extension cavity formed on an underside surface of the keyboard key cap to centrally align the keyboard key cap into the keyboard key well.

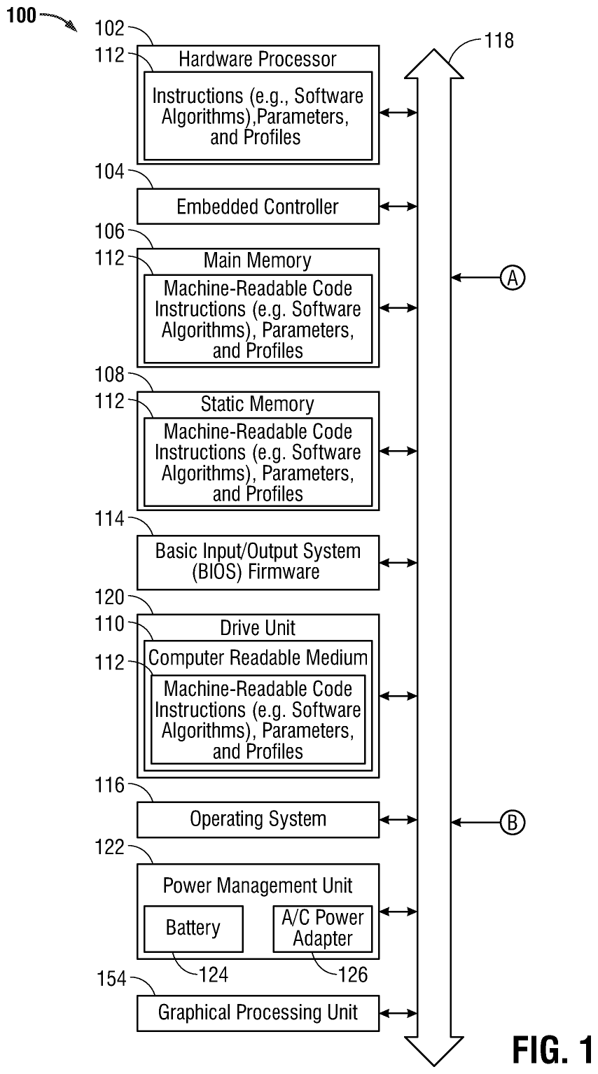

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a server or as a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 154, hardware processor 102, embedded controller (EC) 104, or any combination thereof. Additional components of the information handling system 100 may include one or more storage devices such as static memory 108 or drive unit 120. The information handling system 100 may include or interface with one or more communications ports for communicating with external devices, as well as various input and output (I/O) devices 142, such as the keyboard 146 described herein, a trackpad 150, a mouse 152, a stylus 148, a video/graphics display device 144, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 154, or any other processing device. The information handling system 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In an embodiment, the information handling system 100 may be in wireless communication with the I/O devices 142 such as the keyboard 146 described herein, a mouse 152, video display device 144, stylus 148, or trackpad 150 among other peripheral devices.

The information handling system 100 further includes a video/graphics display device 144. The video/graphics display device 144 in an embodiment may function as a liquid crystal display (LCD), an organic light emitting diode (OLED), a flat panel display, or a solid-state display. Additionally, as described herein, the information handling system 100 may include one or more other I/O devices 142 including the keyboard 146 described herein that allows the user to interface with the information handling system 100 via the video/graphics display device 144 via alphanumeric input, other I/O devices 14 such as a cursor control device (e.g., a trackpad 150, or gesture or touch screen input), and/or a stylus 148, among others. Various drivers and control electronics may be operatively coupled to operate the I/O devices 142 according to the embodiments described herein. The present specification contemplates that the I/O devices 142 may be wired or wireless. In the context of the keyboard 146 described herein, the keyboard 146 is operatively coupled to the information handling system 100 via a wired or wireless connection. Where the keyboard 146 is a wireless keyboard 146, the radio 130, RF front end circuits and antenna 134 may be used to operatively couple the wireless keyboard 146 to the information handling system via, for example, a Bluetooth® or Bluetooth Low Energy (BLE) (e.g., 2.4 GHz or 6 GHz) frequency. Where the keyboard 146 is a wired keyboard 146, the keyboard 146 may be operatively coupled to the information handling system via a wired connection coupled to a universal serial bus (USB) port formed at the information handling system.

A network interface device of the information handling system 100 shown as wireless interface adapter 128 can provide connectivity among devices such as with Bluetooth® (e.g., 2.4 GHz) or to a network 136, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an AP 138 or base station 140 used to operatively couple the information handling system 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, wireless network wireless APs 138 or base stations 140 may be operatively connected to the information handling system 100. Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations may include distributed processing, component/object distributed processing, and parallel processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a device connected to a network 136 may communicate voice, video, or data over the network 136. Further, the instructions 112 may be transmitted or received over the network 136 via the network interface device or wireless interface adapter 128.

The information handling system 100 may include a set of instructions 112 that may be executed to cause the computer system to perform any one or more of the methods or computer-based functions disclosed herein. For example, instructions 112 may be executed by a hardware processor 102, GPU 154, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 154 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 154 of information handling system 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102 and other hardware components described herein. The PMU 122 may control power to one or more components including the one or more drive units 120, the hardware processor 102 (e.g., CPU), the EC 104, the GPU 154, a video/graphic display device 144, or other wired I/O devices 142 such as the stylus 148, a keyboard 146, and a trackpad 150 and other components that may require power when a power button has been actuated by a user. In an embodiment, the PMU 122 may monitor power levels and be electrically coupled to the information handling system 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the information handling system 100, via wired connections as applicable, or when AC power from the AC power adapter 126 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system is operatively coupled to a keyboard 146 either via a wired or wireless connection. The keyboard 146 may include a housing that houses the components of the keyboard. In an embodiment, this housing may be formed into a housing of a laptop-type information handling system 100. In an alternative embodiment, this housing may be a dedicated housing separate from the information handling system 100 via a wired connection. The housing may house a keyboard printed circuit board (PCB) 174 that interfaces with other components to receive input at the keyboard 146 by the user. For example, a layer with an array of keyboard key rubber domes 170 may be placed over the keyboard PCB 174 in an embodiment. In an embodiment, each of the keyboard key rubber domes 170 may include a magnet or metallic material that, when pressed down via a keyboard key cap 158 by a user, completes a circuit connection or triggers a key switch on a key switch and keyboard printed circuit board (PCB) that is interpreted by a hardware processing device (e.g., a dedicated hardware processing device within the keyboard 146 housing or the hardware processor 102) as input from the keyboard 146. In other embodiments herein, the keyboard rubber domes 170 may include a plastic material or rubber material that when pressed down via a keyboard key cap 158 by a user, triggers a key switch on a key switch and keyboard PCB that is interpreted by a hardware processing device (e.g., a dedicated hardware processing device within the keyboard 146 housing or the hardware processor 102) as input from the keyboard 146 In yet other embodiments, the keyboard key cap 158 of the magnetic keyboard keys 156 may insert on or through the rubber domes with an extension of the keycap lower extension or the rubber dome layer that triggers a keyswitch on the keyswitch and keyboard PCB 174.

The keyboard 146 may further include a plurality of magnetic keyboard keys 156. Each of the magnetic keyboard keys 156 may include a keyboard key cap 158 that interfaces mechanically and magnetically with a keyboard key well 164 formed into a keyboard top cover 160. In an embodiment, one or more keyboard key cap magnets 166 are formed onto an outer surface of or lower extension of the keyboard key cap 158. In an embodiment, a plurality of keyboard key cap magnets 166 may be formed on or operatively coupled to the lower extension of the keyboard key cap 158 with a first keyboard key cap magnet 166 operatively coupled to a first side of the keyboard key cap 158 and a second keyboard key cap magnet 166 operatively coupled to a second, perpendicular side of the keyboard key cap 158. By placing these two keyboard key cap magnets 166 on perpendicular sides of the lower extension sliding surface of the keyboard key cap 158, the keyboard key cap 158 may remain properly aligned with the keyboard key well 164 via magnetic interaction with one or more keyboard key well magnets 168 formed within or operatively coupled to the keyboard key well 164.

Similarly, the keyboard key well 164 may include one or more keyboard key well magnets 168 operatively coupled to interior surfaces of the keyboard key well 164. In an embodiment, a plurality of keyboard key well magnets 168 may be formed on or operatively coupled to the interior surface of the keyboard key well. In an embodiment, a first keyboard key well magnet 168 is formed on or operatively coupled to a first side of the keyboard key well 164 with a second keyboard key well magnet 168 being formed on or operatively coupled to a second, perpendicular side of the keyboard key well 164.

In an embodiment, each of the array of keyboard key rubber domes 170 includes a rubber dome retention extension that extends into a retention extension cavity formed on an underside surface of the keyboard key cap 158 to centrally align the keyboard key cap 158 into the keyboard key well 164. The rubber dome retention extension may help to provide support for the keyboard key cap 158 during movement of the keyboard key cap 158 into the keyboard key well 164 when actuated by a user.

In an embodiment, a lubricant 172 is layered between the sliding surface of the keyboard key cap 258 and the interior surface of the keyboard key well 164. This may be done to further reduce the clacking noise between the keyboard key cap 158 and the keyboard key well 164 where present as well as allow the keyboard key cap 158 to interface with the keyboard key well 164 with reduced friction thereby reducing the resistance by the user to actuate the magnetic keyboard key 156.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

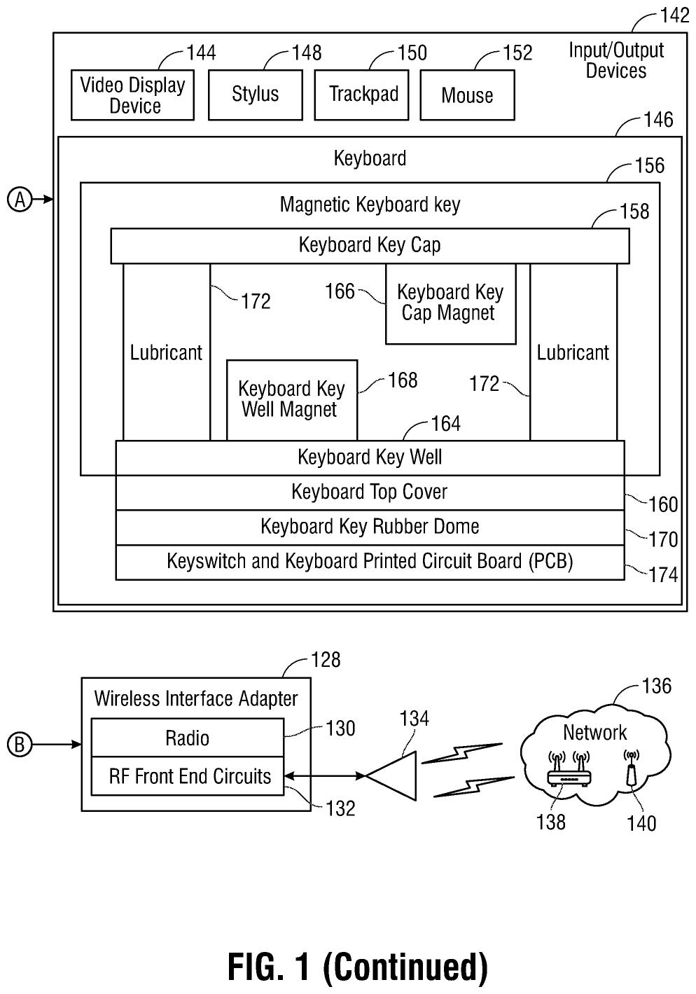

FIG. 2 is a top view of a magnetic keyboard key 256 formed into a keyboard according to an embodiment of the present disclosure. As described herein, the keyboard may include a keyboard top cover 260 with one or more keyboard key wells 264 formed therein. Each keyboard key well 264 may be formed to create an individual magnetic keyboard key 256 therein so that a plurality of keyboard keys may be formed at the keyboard.

The keyboard key well 264 shown in FIG. 2 includes a keyboard key rubber dome 270 extending up into the keyboard key well 264. The keyboard key rubber dome 270 may include a rubber dome retention extension 276 in an embodiment. The rubber dome retention extension 276 extends into a retention extension cavity formed on an underside surface of the keyboard key cap 258 to centrally align the keyboard key cap 228 into the keyboard key well 264. The keyboard key cap 228 is depicted as see-through to show components underneath such as the keycap lower extension. The rubber dome retention extension 276 may help to provide support for the keyboard key cap 258 during movement of the keyboard key cap 258 into the keyboard key well 264 when actuated by a user.

As described herein, the keyboard key cap 258 may include one or more keyboard key cap magnets 266-1, 266-2. In the embodiment shown in FIG. 2, the top of the keyboard key cap 258 may be squared shaped with a bottom portion or lower extension sliding surfaces extending down into the keyboard key well 264. The keyboard key cap 258 may include a first keyboard key cap magnet 266-1 operatively coupled to a first side of the keyboard key cap 258 lower extension. A second keyboard key cap magnet 266-2 may also be operatively coupled to a second side of the keyboard key cap 258 lower extension. The first side of the keyboard key cap 258 and the second side of the keyboard key cap 258 lower extensions may be perpendicular to each other. This causes the first keyboard key cap magnet 266-1 and second keyboard key cap magnet 266-2 to be operatively coupled to sides on the keyboard key cap 258 that are next to or perpendicular to each other for keyboard key cap 258 stability.

Additionally, the keyboard key well 264 may include one or more keyboard key well magnets 268-1, 268-2. In an embodiment, the keyboard key well 264 may include a first keyboard key well magnet 268-1 operatively coupled to a first, interior side of the keyboard key well 264. A second keyboard key well magnet 268-2 may also be operatively coupled to a second, interior side of the keyboard key well 264. The first side of the keyboard key well 264 and the second side of the keyboard key well 264 may be perpendicular to each other. This causes the first keyboard key well magnet 268-1 and second keyboard key well magnet 268-2 to be operatively coupled to interior sides within the keyboard key well 264 that are next to or perpendicular to each other and correspond to keyboard key cap magnet locations on the lower extension of the keyboard key cap 258.

As described herein, the operative coupling of the first keyboard key cap magnet 266-1 to the exterior surface (e.g., a first side) of the keyboard key cap 258 lower extension causes the first keyboard key cap magnet 266-1 to magnetically interface with the first keyboard key well magnet 268-1 formed on a corresponding interior side within the keyboard key well 264. Similarly, the operative coupling of the second keyboard key cap magnet 266-2 to the exterior surface (e.g., a second side) of the keyboard key cap 258 lower extension causes the second keyboard key cap magnet 266-2 to magnetically interface with the second keyboard key well magnet 268-2. This magnetic interaction between these respective magnets 266-1, 268-1 as well as 266-2, 268-2 causes the keyboard key cap 258 to be coupled to and within the keyboard key well 264 thereby preventing or limiting the ability of the keyboard key cap 258 from being removed from within the keyboard key well 264. In an embodiment, the arrangement of these magnets 266-1, 268-1 as well as 266-2, 268-2 may also cause the movement of the keyboard key cap 258 into the keyboard key well 264 to be generally aligned vertically such that friction is reduced when a user actuates the magnetic keyboard key 256.

In an embodiment, a lubricant (not shown) is layered between the sliding surface of the keyboard key cap 258 and the interior surface of the keyboard key well 264. This may be done to further reduce the clacking noise between the keyboard key cap 258 and the keyboard key well 264 where present as well as allow the keyboard key cap 258 to interface with the keyboard key well 264 with reduced friction thereby reducing the resistance by the user to actuate the magnetic keyboard key 256.

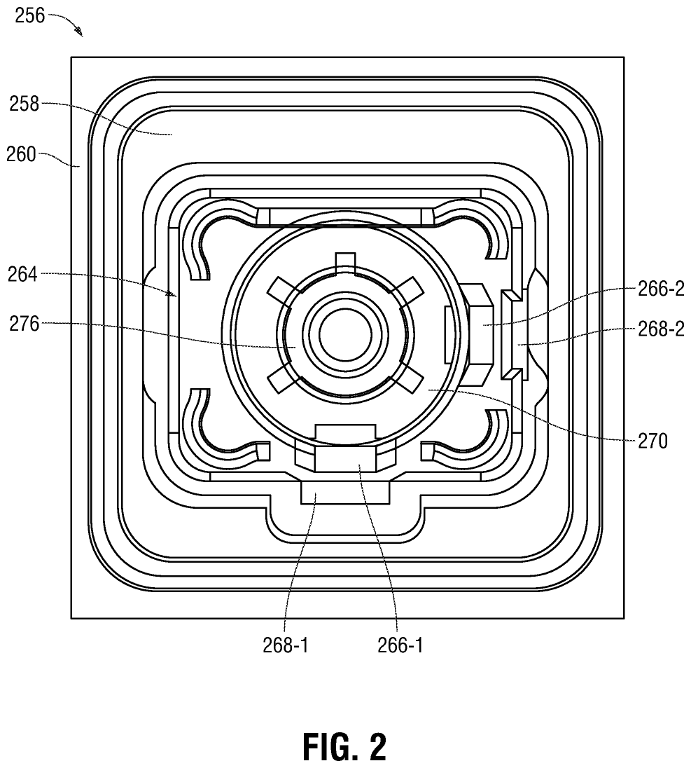

FIG. 3 is a top perspective exploded view of a magnetic keyboard key 356 formed into a keyboard top cover 360 of the keyboard 346 showing a plurality of keyboard key well magnets 366-1, 366-2 and a plurality of keyboard key cap magnets 368-1, 368-2 according to another embodiment of the present disclosure. FIG. 3 shows the keyboard key cap 358 removed away from within the keyboard key well 364 to show an orientation of a first keyboard key well magnet 368-1 and a second keyboard key well magnet 368-2 therein as well as a keyboard key rubber dome 370 and its rubber dome retention extension 376. Again, the keyboard key cap 358 is shown as see-through to illustrate detail underneath including the keyboard keycap lower extension.

As described herein, the keyboard 346 may include a keyboard top cover 360 with one or more keyboard key wells 364 formed therein. Each keyboard key well 364 may be formed to create an individual magnetic keyboard key 356 therein so that a plurality of magnetic keyboard keys 356 may be formed at the keyboard 346.

The keyboard key well 364 shown in FIG. 3 includes a keyboard key rubber dome 370 extending up into the keyboard key well 364. The keyboard key rubber dome 370 may be one of an array of keyboard key rubber domes 370 formed on a keyboard key rubber dome layer. A keyboard PCB (not shown) may be placed under the keyboard key rubber dome layer and may include a circuit or keyswitch under each keyboard key rubber dome 370 for detecting key actuation. In an embodiment, each of the keyboard key rubber domes 370 may include a magnet, metallic material, or other interface that, when pressed down via the keyboard key cap 358 by a user, completes a circuit connection or triggers a keyswitch that is received by and interpreted by a hardware processing device (e.g., a dedicated hardware processing device such as a keyboard controller within the keyboard 346 housing or the hardware processor) as keystroke input from the keyboard 346.

The keyboard key rubber dome 370 may include a rubber dome retention extension 376 in an embodiment. The rubber dome retention extension 376 extends into a retention extension cavity formed on an underside surface of the keyboard key cap 358 to centrally align the keyboard key cap 328 into the keyboard key well 364. The rubber dome retention extension 376 may help to provide support for the keyboard key cap 358 during movement of the keyboard key cap 358 into the keyboard key well 364 when actuated by a user.

As described herein, the keyboard key cap 358 may include one or more keyboard key cap magnets 366-1, 366-2. In the embodiment shown in FIG. 3, the top of the keyboard key cap 358 may be generally square shaped or rectangular with a bottom portion or lower extension sliding surfaces that, when coupled to the keyboard key well 364, extend down into the keyboard key well 364. The keyboard key cap 358 may include a first keyboard key cap magnet 366-1 operatively coupled to a first side of the keyboard key cap 358 lower extension. A second keyboard key cap magnet 366-2 may also be operatively coupled to a second side of the keyboard key cap 358 lower extension. The first side of the keyboard key cap 358 and the second side of the keyboard key cap 358 may be perpendicular to each other in an embodiment. This causes the first keyboard key cap magnet 366-1 and second keyboard key cap magnet 366-2 to be operatively coupled to sides on the keyboard key cap 358 lower extension that are next to and perpendicular to each other.

Additionally, the keyboard key well 364 may include one or more keyboard key well magnets 368-1, 368-2. In an embodiment, the keyboard key well 364 may include a first keyboard key well magnet 368-1 operatively coupled to a first, interior side of the keyboard key well 364. A second keyboard key well magnet 368-2 may also be operatively coupled to a second, interior side of the keyboard key well 364. The first side of the keyboard key well 364 and the second side of the keyboard key well 364 may be perpendicular to each other. This causes the first keyboard key well magnet 368-1 and second keyboard key well magnet 368-2 to be operatively coupled to interior sides within the keyboard key well 364 that are next to and perpendicular to each other.

As described herein, the coupling of the first keyboard key cap magnet 366-1 to the exterior surface (e.g., a first side) of the keyboard key cap 358 lower extension causes the first keyboard key cap magnet 366-1 to magnetically interface with the first keyboard key well magnet 368-1 formed on a corresponding interior side within the keyboard key well 364. Similarly, the coupling of the second keyboard key cap magnet 366-2 to the exterior surface (e.g., a second side) of the keyboard key cap 358 lower extension causes the second keyboard key cap magnet 366-2 to magnetically interface with the second keyboard key well magnet 368-2. This magnetic interaction between these respective magnets 366-1, 366-2, 368-1, 368-2 causes the keyboard key cap 358 to be coupled to and within the keyboard key well 364 thereby preventing or limiting the ability of the keyboard key cap 358 from being removed from within the keyboard key well 364. In an embodiment, the arrangement of these magnets 366-1, 366-2, 368-1, 368-2 may also cause the movement of the keyboard key cap 358 into the keyboard key well 364 to be generally vertical such that friction is reduced when a user actuates the magnetic keyboard key 356.

In an embodiment, a lubricant (not shown) is layered between the sliding surface of the keyboard key cap 358 and the interior surface of the keyboard key well 364. The lubricant may be layered onto the interior surfaces of the keyboard key well 364 prior to coupling of the keyboard key cap 358 into the keyboard key well 364 in an embodiment. The use of a lubricants may further reduce the clacking noise between the keyboard key cap 358 and the keyboard key well 364 where present as well as allow the keyboard key cap 358 to interface with the keyboard key well 364 with reduced friction thereby reducing the resistance by the user to actuate the magnetic keyboard key 356.

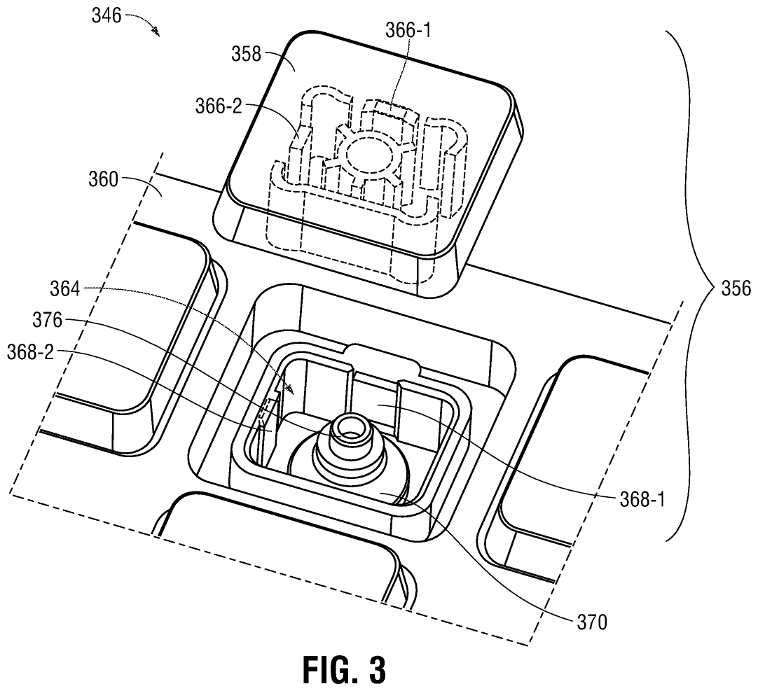

FIG. 4 is a top perspective view of a magnetic keyboard key well 464 formed into the keyboard showing a plurality of keyboard key well magnets 468-1, 468-2 according to an embodiment of the present disclosure. FIG. 4 shows the keyboard key cap (not shown) removed away from within the keyboard key well 464 to show a closer view of the keyboard key well 464.

The keyboard key well 464 shown in FIG. 4 includes a keyboard key rubber dome 470 extending up into the keyboard key well 464. The keyboard key rubber dome 470 may be one of an array of keyboard key rubber domes 470 formed on a keyboard key rubber dome layer. A keyboard PCB (not shown) may be placed under the keyboard key rubber dome layer and may include a circuit or switch under each keyboard key rubber dome 470. In an embodiment, each of the keyboard key rubber domes 470 may include a magnet, metallic material, or another material that, when pressed down via the keyboard key cap 458 by a user, completes a circuit connection or triggers a key switch that is part of a keyswitch and keyboard PCB. Triggering a key switch is interpreted by a hardware processing device (e.g., a dedicated hardware processing device within the keyboard 446 housing or the hardware processor) as keystroke input from the keyboard 446.

The keyboard key rubber dome 470 may include a rubber dome retention extension 476 in an embodiment. The rubber dome retention extension 476 extends into a retention extension cavity formed on an underside surface of the keyboard key cap to centrally align the keyboard key cap into the keyboard key well 464. The rubber dome retention extension 476 may help to provide support for the keyboard key cap during movement of the keyboard key cap into the keyboard key well 464 when actuated by a user.

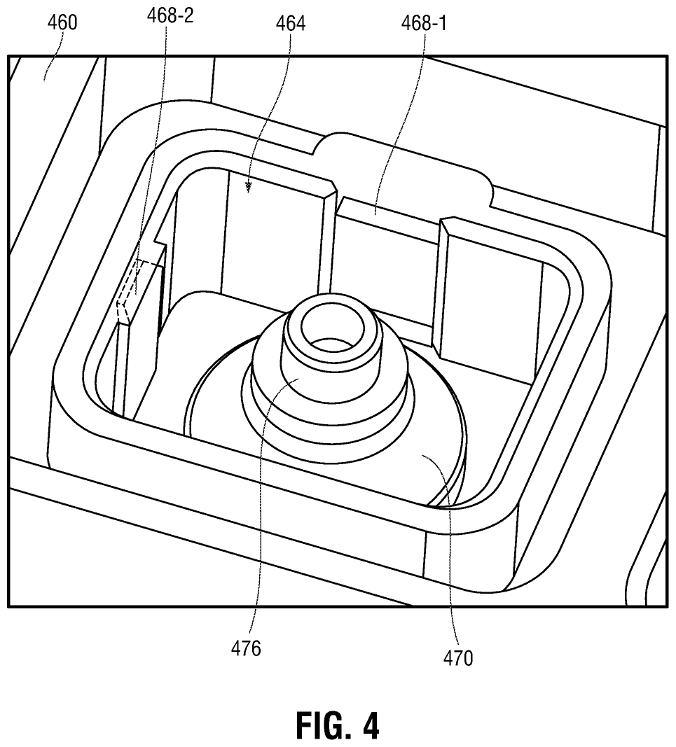

FIG. 5 is a bottom perspective view of a keyboard key cap 558 of a keyboard showing the plurality of keyboard key cap magnets 566-1, 566-2 on a key cap lower extension 578 according to another embodiment of the present disclosure. FIG. 5 shows the removal of the keyboard key cap 558 from the keyboard key well that is described in FIG. 4.

As described herein, the keyboard key cap 558 may include one or more keyboard key cap magnets 566-1, 566-2. The top of the keyboard key cap 558 may be square-shaped, rectangular, or any other suitable keyboard key shape with a bottom portion or lower extension 578 having sliding surfaces that, when operatively coupled to the keyboard key well 564, extend down into the keyboard key well formed into the keyboard top cover. It is contemplated that any shaped keyboard key and keyboard key cap 558 may be formed with the keyboard key cap magnets 566-1, 566-2 on a key cap lower extension 578 according to embodiments herein. In an embodiment, the lower extension 578 with sliding surfaces may conform to interior surfaces within the keyboard key well and may be moved within the keyboard key well via application of a lubricant between the lower extension 578 sliding surfaces (e.g., exterior surfaces of the keyboard key cap 558) and interior surfaces within the keyboard key well.

The keyboard key cap 558 may include a first keyboard key cap magnet 566-1 operatively coupled to a first side of the keyboard key cap 558 lower extension. A second keyboard key cap magnet 566-2 may also be operatively coupled to a second side of the keyboard key cap 558 lower extension. The first side of the keyboard key cap 558 and the second side of the keyboard key cap 558 may be perpendicular to each other for key cap stability in the keyboard key well 564. This causes the first keyboard key cap magnet 566-1 and second keyboard key cap magnet 566-2 to be operatively coupled to sides on the keyboard key cap 558 lower extension that are next to each other.

As described herein, the keyboard key cap 558 includes a retention extension cavity 580 formed at an underside of the keyboard key cap 558. The rubber dome retention extension of the rubber dome described herein may be inserted into this retention extension cavity 580. The insertion of the rubber dome retention extension into the retention extension cavity 580 helps to provide support and alignment for the keyboard key cap during movement of the keyboard key cap 558 into the keyboard key well when actuated by a user.

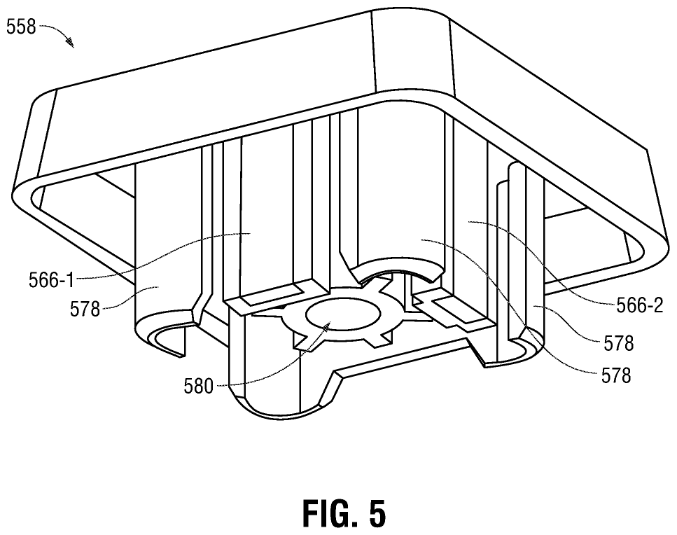

FIG. 6 is a side, cross-sectional view of a magnetic keyboard key 656 of a keyboard in an unactuated state according to an embodiment of the present disclosure. FIG. 6 shows the keyboard key cap 658 engaged with the keyboard key well 664 via use of one or more keyboard key cap magnets 666 magnetically interfacing with one or more keyboard key well magnets 668 as described in some embodiments herein.

As described herein, the keyboard key cap 658 may include one or more keyboard key cap magnets 666. The top of the keyboard key cap 658 may be square-shaped, rectangular shaped, or any suitable key shape with a bottom portion or lower extension 678 with sliding surfaces that, when coupled to the keyboard key well 664, extend down into the keyboard key well 664 formed into the keyboard top cover 660. In an embodiment, the lower extension 678 sliding surfaces may conform to interior surfaces within the keyboard key well 664 and may be moved within the keyboard key well via application of a lubricant between the lower extension 678 sliding surfaces (e.g., exterior surfaces of the keyboard key cap 658) and interior surfaces within the keyboard key well 664.

The keyboard key cap 658 may include a keyboard key cap magnet 666 operatively coupled to a side of the keyboard key cap 658. It is appreciated that any number of keyboard key cap magnets 666 may be used to secure the keyboard key cap 658 into the keyboard key well 664. In an embodiment, the keyboard key cap magnet 666 may be any type of magnet including permanent magnets such as neodymium magnets or types of magnets.

Additionally, the keyboard key cap 658 includes a retention extension cavity 680 formed at the underside of the keyboard key cap 658. The rubber dome retention extension 676 of the rubber dome 670 described herein may be inserted into this retention extension cavity 680. The insertion of the rubber dome retention extension 676 into the retention extension cavity 680 helps to provide support and alignment for the keyboard key cap 658 during movement of the keyboard key cap 658 into the keyboard key well 664 when actuated by a user.

The keyboard key well 664 shown in FIG. 6 includes a keyboard key rubber dome 670 extending up into the keyboard key well 664. The keyboard key rubber dome 670 may be one of an array of keyboard key rubber domes 670 formed on a keyboard key rubber dome layer. A keyboard PCB (not shown) may be placed under the keyboard key rubber dome layer and may include a circuit or keyswitch structure under each keyboard key rubber dome 670. In an embodiment, each of the keyboard key rubber domes 670 may include a magnet or metallic material that, when pressed down via the keyboard key cap 658 by a user, completes a circuit connection that is interpreted by a hardware processing device (e.g., a dedicated hardware processing device within the keyboard housing or the hardware processor) as input from the keyboard. In other embodiments, an extension of another material, such as plastic, may trigger a keyswitch.

FIG. 6 also shows the keyboard key well 664 may include one or more keyboard key well magnets 668 operatively coupled to interior surfaces of the keyboard key well 664. In an embodiment, any number of keyboard key well magnets 668 may be used to interact with any corresponding number of keyboard key cap magnets 666 so that the keyboard key cap 658 may be retained within the keyboard key well 664. In an embodiment, the magnetic poles of the keyboard key cap magnet 666 and the keyboard key well magnet 668 that face each other are opposing poles (“north” pole facing “south” pole) such that the magnetic interaction is an attractive magnetic interaction. The magnetic strength of the keyboard key cap magnet 666 and keyboard key well magnet 668 may be such as to allow the movement of the keyboard key cap 658 into the keyboard key well 664 when actuated by a user but not cause the magnets to touch. In an embodiment, the magnetic strength of the keyboard key cap magnet 666 and keyboard key well magnet 668 may be sufficient to prevent removal of the keyboard key cap 658 from within the keyboard key well 664 by a user without a significant force. This allows the keyboard key cap 658 to be retained within the keyboard key well 664 even when and if the keyboard has been turned upside down while aligning actuation movement of the keyboard keys 656.

In an unactuated state, the magnetic keyboard key 656 shown in FIG. 6 includes an undeformed keyboard key rubber dome 670. The strength of the keyboard key rubber dome 670 may keep the keyboard key cap 658 further away from the keyboard top cover 660 such that a magnetic or metal contact 682 or other key switch extension type formed at a bottom underside of the keyboard key rubber dome 670 does not contact a key switch or circuit connection when the keyboard key cap 658 is not pressed or actuated by a user. Additionally, in an unactuated state, the keyboard key cap magnet 666 and keyboard key well magnet 668 may be attracted to each other but slightly vertically offset.

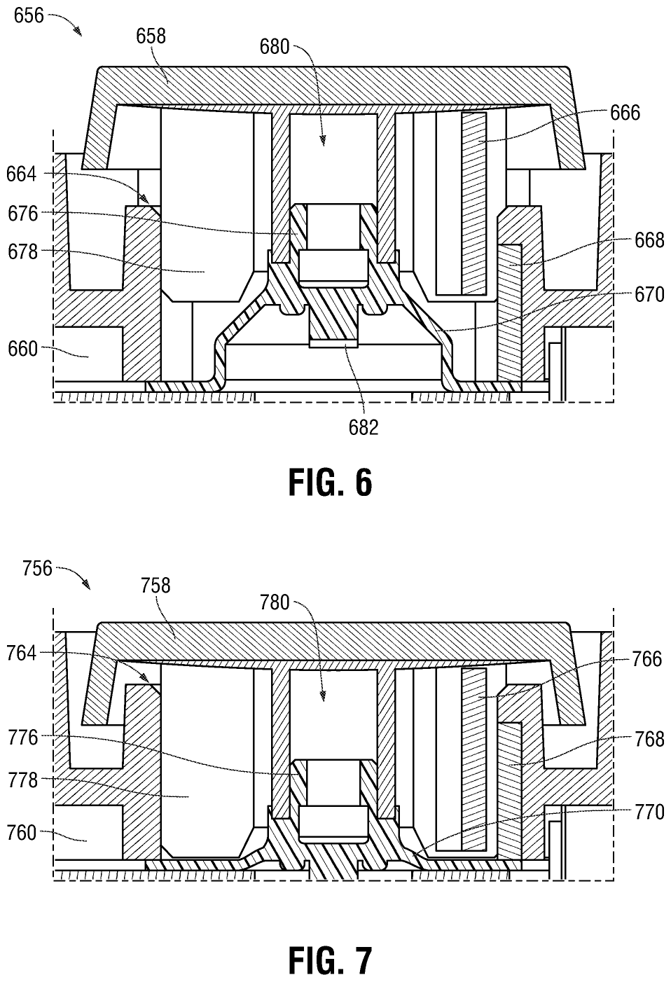

FIG. 7 is a side, cross-sectional view of a magnetic keyboard key 756 of a keyboard in an actuated state according to an embodiment of the present disclosure. As described herein, the keyboard key cap 758 may include one or more keyboard key cap magnets 766. The top of the keyboard key cap 758 may be square-shaped rectangular, or any suitable keyboard key shape with a bottom portion or lower extension 778 with sliding surfaces that, when coupled to the keyboard key well 764, extend down into the keyboard key well 764 formed into the keyboard top cover 760. In an embodiment, the lower extension 778 sliding surfaces may conform to interior surfaces within the keyboard key well 764 and may be moved within the keyboard key well via application of a lubricant between the lower extension 778 sliding surfaces (e.g., exterior surfaces of the keyboard key cap 758) and interior surfaces within the keyboard key well 764.

The keyboard key cap 758 may include a keyboard key cap magnet 766 operatively coupled to a side of the keyboard key cap 758. It is appreciated that any number of keyboard key cap magnets 766 may be used to secure the keyboard key cap 758 into the keyboard key well 764. In an embodiment, the keyboard key cap magnet 766 may be any type of magnet including permanent magnets such as neodymium magnets or other magnets.

Additionally, the keyboard key cap 758 includes a retention extension cavity 780 formed at an underside of the keyboard key cap 758. The rubber dome retention extension 776 of the rubber dome 770 described herein may be inserted into this retention extension cavity 780. The insertion of the rubber dome retention extension 776 into the retention extension cavity 780 helps to provide support and alignment for the keyboard key cap 758 during movement of the keyboard key cap 758 within the keyboard key well 764 when actuated by a user.

The keyboard key well 764 shown in FIG. 7 includes a keyboard key rubber dome 770 extending up into the keyboard key well 764. The keyboard key rubber dome 770 may be one of an array of keyboard key rubber domes 770 formed on a keyboard key rubber dome layer. A keyboard PCB (not shown) may be placed under the keyboard key rubber dome layer and may include a circuit or key switch under each keyboard key rubber dome 770. In an embodiment, each of the keyboard key rubber domes 770 may include a magnet, metallic material, or other extension material that, when pressed down via the keyboard key cap 758 by a user, completes a circuit connection or triggers a key switch that is interpreted by a hardware processing device (e.g., a dedicated hardware processing device within the keyboard housing or the hardware processor) as keystroke input from the keyboard.

FIG. 7 also shows the keyboard key well 764 may include one or more keyboard key well magnets 768 operatively coupled to interior surfaces of the keyboard key well 764. In an embodiment, any number of keyboard key well magnets 768 may be used to interact with any corresponding number of keyboard key cap magnets 766 so that the keyboard key cap 758 may be retained within the keyboard key well 764. In an embodiment, the magnetic poles of the keyboard key cap magnet 766 and the keyboard key well magnet 768 that face each other are opposing poles (“north” pole facing “south” pole) such that the magnetic interaction is an attractive magnetic interaction. The magnetic strength of the keyboard key cap magnet 766 and keyboard key well magnet 768 may be such as to allow the movement of the keyboard key cap 758 into the keyboard key well 764 when actuated by a user without causing the magnets to contact one another. In an embodiment, the magnetic strength of the keyboard key cap magnet 766 and keyboard key well magnet 768 may be sufficient to prevent removal of the keyboard key cap 758 from within the keyboard key well 764 by a user without a force to overcome the magnetic attraction. This allows the keyboard key cap 758 to be retained within the keyboard key well 764 even when and if the keyboard has been turned upside down but still move up and down within the key well. This arrangement reduces or eliminates the clacking noise usually associated with the actuation and release of a keyboard key and specifically the clacking noise created by the interaction between the key cap and the key well or keyboard top cover in previous keyboards.

In an actuated state, the magnetic keyboard key 756 shown in FIG. 7 includes a deformed keyboard key rubber dome 770. The strength of the keyboard key rubber dome 770 may such that a user, pressing down on the keyboard key cap 658, may overcome the physical force of the keyboard key rubber dome 670 forcing the keyboard key cap 658 up. The magnetic interactions between the plural keyboard key well magnets 668 and the plural keyboard key cap magnets 666 hold the keyboard key cap 658 in alignment in the keyboard key well 664. When the keyboard key rubber dome 670 is deformed and is overcome via the force applied to the keyboard key cap 658 by the user, a magnetic or metal contact (not shown) formed at a bottom underside of the keyboard key rubber dome 770 is guided by the magnetic interaction between the keyboard key cap magnet 666 and keyboard key well magnet 668 to contact a key switch or circuit connection formed on a keyboard PCB thereby actuating the key switch or closing the circuit. This is interpreted as input provided by the keyboard to the information handling system. Additionally, in an actuated state, the keyboard key cap magnet 766 and keyboard key well magnet 768 may be attracted to each other and may be more vertically aligned than in the unactuated state shown in FIG. 6.

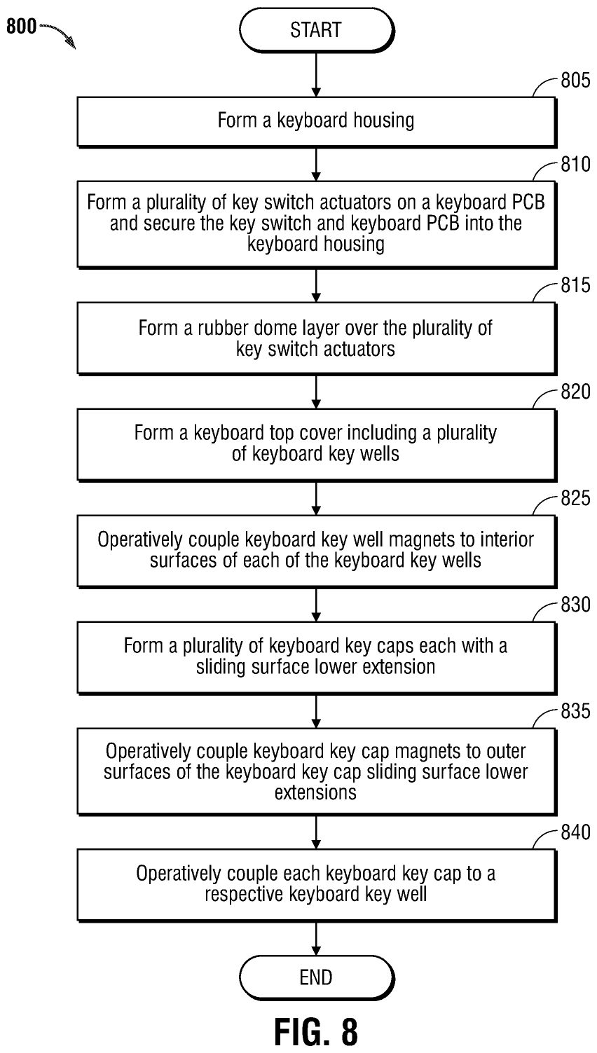

FIG. 8 is a block flow diagram illustrating a method 800 of manufacturing a keyboard according to an embodiment of the present disclosure. The method 800 may include, at block 805, forming a keyboard housing. As described herein, the keyboard may be a keyboard of a laptop-type information handling system, a wired keyboard operatively coupled to a USB port of an information handling system, or a wireless keyboard operatively coupled to an information handling system via a radio and antenna. Each of these types of keyboards may include a housing such as with a laptop-type keyboard where the housing may include a base chassis that may also house a processing device, a cooling system, a hard drive, and other components of the information handling system. A standalone keyboard housing may include a microcontroller unit (MCU), a keyboard radio, a PCB, a battery, power management unit (PMU), and other hardware described herein.

At block 810, the method 800 further includes forming a plurality of key switch actuators on a keyboard printed circuit board (PCB). The keyboard PCB may include any components such as electrical traces and the key switch actuators that transmit electrical input signals to a hardware processor indicating when actuation of a keyboard key occurs in some example embodiments. This keyboard PCB may also be secured into the keyboard housing using, for example, fasteners such as hooks, posts, screws, interference fit, or adhesives such as a glue.

At block 815, a rubber dome layer is formed over the plurality of key switch formed on the keyboard PCB. As described herein, this rubber dome layer includes a plurality of rubber domes formed over each of the plurality of key switches formed on the PCB. It is appreciated that these rubber domes are one example of the physical keyswitch actuation devices that allow a user to press the keyboard key down with the physical keyswitch actuation device causing the keyboard key to be returned back to an unpressed state as well as be able to provide input at the keyboard. The present specification contemplates that other types of physical keyswitch actuation devices such as a scissor-switch device or a butterfly switch device, among other types, may also be used. With the rubber domes (e.g., as shown in FIGS. 2, 3,4,6, and 7), however, a metal element, magnet, or other contacting device may be formed under the rubber dome that is used to contact with a metal contact of a circuit or trigger the key switch formed on the keyboard PCB. The contact of the metal element with the metal contact or other triggering extension type of the key switch on the PCB completes a circuit causing keystroke input to be received at the keyboard key. This input is interpreted at a processing device (e.g., a keyboard controller, a hardware processing device, an embedded controller, a GPU, etc.) as keyboard input from the specific key (e.g., space bar input from the space bar).

The method 800 may include forming a keyboard top cover at block 820. The keyboard top cover may include a number of keyboard key wells where keyboard key caps may be operatively coupled to the keyboard as described herein. Again, the arrangement of these keys may depend on a chosen layout selected such as that with a QWERTY-type keyboard.

The method 800 may include, at block 825, operatively coupling one or more keyboard key well magnets onto interior surfaces of each of the keyboard key wells formed into the keyboard top cover. Each of the keyboard key wells may include one or more keyboard key well magnets. In an embodiment, the keyboard key wells may include a first keyboard key well magnet operatively coupled to a first, interior side of the keyboard key well. A second keyboard key well magnet may also be operatively coupled to a second, interior side of the keyboard key well. The keyboard key well magnets may be operatively coupled to the sides of the keyboard key wells via interference fit, inserting the magnets into a molded holder with one or more clips, hooks, posts or other fasteners, fastened to the sides of the key board key wells with a fastener, adhered to the sides of the keyboard key well via adhesive or operatively coupled via any other method. The first side of the keyboard key well and the second side of the keyboard key well may be perpendicular to each other. This causes the first keyboard key well magnet and second keyboard key well magnet to be operatively coupled to interior sides within the keyboard key well that are next to each other.

At block 830, the method 800 includes forming a plurality of keyboard key caps. As described herein, the keyboard key caps 658 may be formed to represent an individual key of, for example, a QWERTY-type keyboard. However, the present specification contemplates that other layouts of individual keyboard keys. In an embodiment, the keyboard key caps may be formed by plastic injection molding for example. The keyboard key caps may be any shape with lower extensions below for insertion into a keyboard key well. The keyboard key well may have a cavity for receiving a rubber dome that includes a rubber dome retention extension formed at a top surface of the rubber dome. In an embodiment, this rubber dome retention extension passes into a retention extension cavity formed on an underside surface of the keyboard key cap to centrally align the keyboard key cap into the keyboard key well.

At block 835, the method 800 includes operatively coupling one or more keyboard key cap magnets to outer surfaces of the lower extension portion of each of the keyboard key caps. The keyboard key caps may include a first keyboard key cap magnet operatively coupled to a first side of the keyboard key cap lower extension. A second keyboard key cap magnet may also be operatively coupled to a second side of the keyboard key cap. In an embodiment, the first keyboard key cap magnet and second keyboard key cap magnet may be operatively coupled to the keyboard key caps during, for example, an injection molding process by inserting the first keyboard key cap magnet and second keyboard key cap magnet prior to injection of the plastic or other material into the mold. In another embodiment, the first keyboard key cap magnet and second keyboard key cap magnet may be operatively coupled to the keyboard key caps using, for example, interference fit, fasteners such as hooks, posts, screws, or adhesives such as a glue or any other method. The first side of the keyboard key cap and the second side of the keyboard key cap lower extension may be perpendicular to each other. This causes the first keyboard key cap magnet and second keyboard key cap magnet to be operatively coupled to sides on the keyboard key cap that are next to each other on the keyboard key cap lower extension for insertion into the keyboard key well.

The method 800 may further include, at block 840, operatively coupling each keyboard key cap to a respective keyboard key well. In an embodiment, this may be done by passing the rubber dome retention extension into the retention extension cavity formed in the keyboard key cap. Additionally, as the keyboard key cap is passed into the keyboard key well, the sliding surfaces lower extension cause the keyboard key cap to be aligned within the keyboard key well. In embodiments where a plurality of keyboard key cap magnets and a plurality of keyboard key well magnets are used for each of the lower extensions of the keyboard key caps, these respective magnets may be aligned so that each keyboard key cap magnet interacts with a keyboard key well magnet to hold the key caps in the keyboard key wells but avoid noisy collisions during actuation. At this point, the method 800 may end.

The blocks of the flow diagrams of FIG. 8 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

1. A keyboard operatively couplable to an information handling system comprising:
a keyboard top cover including at least one keyboard key well formed therein;
a keyboard key cap having a lower extension structure extending from the bottom of the keyboard keycap with a sliding surface to fit within the keyboard key well;
a keyboard key well magnet formed on an interior vertical surface inside a keyboard key well sidewall of the keyboard key well; and
a keyboard key cap magnet formed on an outer surface of the lower extension structure extending from the keyboard key cap aligned in parallel vertically with the keyboard key well magnets arranged on the interior vertical surface inside the keyboard key well sidewall, wherein magnetic interaction between the keyboard key well magnet and the keyboard key cap magnet slidably holds the lower extension structure extending from keyboard key cap to the keyboard key well.

2. The keyboard of claim 1 further comprising:
a lubricant layered between the lower extension structure and the sliding surface of the keyboard key cap and the interior surface of the keyboard key well sidewall.

3. The keyboard of claim 1 further comprising:
a plurality of keyboard key well magnets formed on the interior surface of keyboard key well sidewalls, wherein a first keyboard key well magnet is formed on a first side vertical surface inside the keyboard key well sidewall and a second keyboard key well magnet is formed on a second, perpendicular side vertical surface inside the keyboard key well sidewall.

4. The keyboard of claim 1 further comprising:
a plurality of keyboard key cap magnets formed on the lower extension structure extending from the keyboard key cap, wherein a first keyboard key cap magnet is formed on a first side of the keyboard key cap lower extension structure and a second keyboard key cap magnet is formed on a second, perpendicular side of the keyboard key cap lower extension structure.

5. The keyboard of claim 1 further comprising:
a keyboard key rubber dome formed within the keyboard key well;
wherein the rubber dome provides an upward force on the keyboard key cap while the magnetic interaction between the keyboard key cap magnet and keyboard key well magnet slidable holds the lower extension structure extending from the keyboard key cap in the keyboard key well.

6. The keyboard of claim 5 further comprising:
a rubber dome retention extension formed at a top surface of the rubber dome, wherein the rubber dome retention extension passes into a retention extension cavity formed on an underside surface of the keyboard key cap lower extension extending from the keyboard key cap to centrally align the lower extension structure extending from the keyboard key cap into the keyboard key well.

7. The keyboard of claim 1, wherein the keyboard key well magnet and the keyboard key cap magnet are arranged to have opposite poles facing each other and relative to each other.

8. A method of manufacturing a keyboard comprising:
forming a keyboard top cover including forming at least one keyboard key well into the keyboard top cover;
forming a keyboard key cap with a lower extension structure extending from the keyboard key cap to fit within the keyboard key well sidewalls of the keyboard key well including sliding surfaces on the lower extension structure that align with interior surfaces of the keyboard key well sidewalls;
operatively coupling a first keyboard key well magnet vertically onto a first interior surface of a keyboard key well sidewall inside the keyboard key well;
operatively coupling a first keyboard key cap magnet onto a first exterior side on the lower extension structure extending from the keyboard key cap to be disposed parallel to the keyboard key well magnet on the keyboard key well sidewall; and
operatively coupling the keyboard key cap to the keyboard key well by sliding the sliding surfaces on the lower extension structure extending from the keyboard key cap into the keyboard key well to fit within the keyboard key well sidewalls, wherein magnetic interaction between the first keyboard key cap magnet and the first keyboard key well magnet slidably holds the keyboard key cap to the keyboard key well.

9. The method of claim 8 further comprising:
applying a layer of lubricant between the sliding surface of the lower extension structure extending from the keyboard key cap and the interior surface of the keyboard key well sidewalls of the keyboard key well.

10. The method of claim 8 further comprising:
operatively coupling a second keyboard key well magnet vertically onto a second interior surface of a second keyboard key well sidewall of the keyboard key well, wherein the first keyboard key well magnet is formed on the first keyboard key well sidewall of the keyboard key well and the second keyboard key well magnet is formed on the second keyboard key well sidewall of the keyboard key well that is perpendicular to the first keyboard key well sidewall of the keyboard key well.

11. The method of claim 8 further comprising:
operatively coupling a second keyboard key cap magnet onto a second exterior side of the lower extension structure extending from the keyboard key cap, wherein the first keyboard key cap magnet is formed on the first exterior side of the lower extension structure extending from the keyboard key cap and the second keyboard key cap magnet is formed on a second, perpendicular side of the lower extension structure extending from the keyboard key cap.

12. The method of claim 8 further comprising:
forming a keyboard printed circuit board (PCB) under the keyboard top cover and forming a keyboard rubber dome layer having at least one keyboard key rubber dome over the keyboard PCB; and
orienting the keyboard rubber dome layer under the keyboard top cover to align and insert the at least one keyboard key rubber dome into the at least one keyboard key well, wherein the rubber dome provides an upward force on the keyboard key cap while the magnetic interaction between the keyboard key cap magnet and keyboard key well magnet slidably hold the keyboard key cap at the keyboard key well.

13. The method of claim 8, further comprising:
forming a rubber dome layer with an array of keyboard key rubber domes under the keyboard top cover; and
forming a rubber dome retention extension at a top surface of each of the rubber domes of the array of keyboard key rubber domes, wherein the rubber dome retention extension passes into a retention extension cavity formed on an underside surface of the keyboard key cap to centrally align the lower extension structure extending from the keyboard key cap into the keyboard key well.

14. The method of claim 8, wherein the first keyboard key well magnet and the key cap keyboard key cap magnet are arranged to have opposite poles facing each other and relative to each other when the lower extension structure extending from the keyboard key cap is installed in the keyboard key well.

15. A keyboard comprising:
a keyboard top cover including a plurality of keyboard key wells formed therein;
a plurality of keyboard key caps each having a keyboard key cap lower extension structure extending from the keyboard key cap with a sliding surface to each fit within keyboard key well sidewalls of the plurality of keyboard key wells;
a keyboard key well magnet formed on an interior surface of the keyboard key well sidewalls of each of the keyboard key wells;
a keyboard key rubber dome layer comprising a plurality of keyboard key rubber domes, the keyboard key rubber dome layer formed under the keyboard top cover with a rubber dome of the plurality of keyboard key rubber dome inserted within each of the plurality of keyboard key wells; and
a keyboard key cap magnet formed on an outer surface of at least one of the sides of the keyboard key cap lower extension structure extending from of each of the plurality of keyboard key caps, wherein magnetic interaction between the keyboard key well magnets and the keyboard key cap magnets slidably holds each of the keyboard key caps to their respective keyboard key wells.

16. The keyboard of claim 15 further comprising:
a lubricant layered between each of the sliding surfaces of the keyboard key cap lower extension structure extending from each of the plurality of keyboard key caps and the interior surfaces of the keyboard key well sidewalls of each of the keyboard key wells.

17. The keyboard of claim 15 further comprising:
a plurality of keyboard key well magnets formed on the interior surfaces of the keyboard key well sidewalls of each of the plurality of keyboard key wells, wherein a first keyboard key well magnet is formed on a first keyboard key well sidewall in each of the plurality of keyboard key wells and a second keyboard key well magnet is formed on a second keyboard key well sidewall that is perpendicular to the first keyboard key well sidewall in each of the keyboard key wells.

18. The keyboard of claim 15 further comprising:
a plurality of keyboard key cap magnets formed on each of the keyboard key cap lower extension structures extending from each of the keyboard key caps, wherein a first keyboard key cap magnet is formed on a first side of each of the keyboard key cap lower extensions and a second keyboard key cap magnet is formed on a second, perpendicular side of each of the keyboard key cap lower extensions.

19. The keyboard of claim 15 further comprising:
a rubber dome retention extension formed at a top surface of each of the plurality of rubber domes, wherein each of the rubber dome retention extensions passes into a retention extension cavity formed inside of the keyboard key cap lower extension structures extending from each of the plurality of keyboard key caps to centrally align the keyboard key cap lower extension structures extending from each of the plurality of keyboard key caps into corresponding keyboard key wells.

20. The keyboard of claim 15, wherein each of the plurality of keyboard key well magnets and corresponding plurality of keyboard key cap magnets are arranged parallel to have opposite poles facing each other and relative to each other when the keyboard key cap lower extension structures extending from each keyboard key cap are installed within each corresponding keyboard key well.
